(19) United States
(12) Patent Application Publication
(10) Pub. No.: US 2007/0050206 A1
(43) Pub. Date: Mar. 1, 2007

(54) Method and apparatus for operating data management and control

(75) Inventors: David L. Whikehart, Findlay, OH (US); Dan Schwartz, Findlay, OH (US); Robert K. Edds, Findlay, OH (US); Scott Perrault, Findlay, OH (US); Kevin Coffey, Findlay, OH (US)

Correspondence Address: EMCH, SCHAFFER, SCHAUB & PORCELLO CO, P O BOX 916, ONE SEAGATE SUITE 1980, TOLEDO, OH, 43697, US

(73) Assignee: Marathon Petroleum Company LLC

(21) Appl. No.: 11/296,751

(22) Filed: Dec. 7, 2005

Related U.S. Application Data
(63) Continuation-in-part of application No. 10/973,586, filed on Oct. 26, 2004.

(51) Int. Cl. G06Q 50/00

(52) U.S. Cl. 705/2; 705/28

(57) ABSTRACT

By integrating supply chain data, verifying the data and converting it into a universal and consistent formal electronically, the invention provides real time, accurate information. With the addition of a supply chain monitoring and alerting component, the invention provide sup to the minute information and alerts that help managers make decisions that avoid supply chain interruptions or anomalies. By providing visual access to a variety of product inventories through a web browser, the invention provides a simplified method for personnel to view and make business decisions based on inventories. The invention provides complete supply chain and operational data that assist organizations identify and manage changes and opportunities in the market.

### CROSS REFERENCE TO RELATED APPLICATION

This application is a continuation-in-part of U.S. application Ser. No. 10/973,586, filed Oct. 26, 2004.

### TECHNICAL FIELD

This invention relates to a system for developing and maintaining business information. More specifically, this invention relates to operations monitoring and logistical data integration and visualization. The system provides real world operations monitoring and logistical data which is shared, viewed and accessed among interrelated business units, thereby providing an organized integrated data repository of all operations. Even more specifically, the invention is a collection of processes, mechanisms, and frameworks that: gather supply chain, inventory, transportation and other logistics data from multiple sources; verify, translate, integrate and store the data; comply with and implement business rules; provide data to other applications; enable other applications to acquire data; present data to users in a variety of online, printed and other formats; and provide optimization, monitors, and exception reporting regarding the data in a variety of manners.

### BACKGROUND OF THE INVENTION

Businesses are under ever increasing pressure to perform faster and more efficiently. Recently, many businesses have focused on logistics to meet these increasing demands. Logistics tracks the flow of a business' product and/or materials, whether that product/material consists of goods, machines, data or services. There is a current business demand for tools which capture and visualize logistics across organizational frameworks, both within a specific company and also with related or interested third parties.

The inventors originally sought to find an existing system to provide a comprehensive logistic solution and found that all existing systems suffer from a number of problems. Current logistic systems perform limited subsets of logistical functions. Disparate systems focus on distinct corporate functions, for example, accounting, and treat logistics tangentially. Existing systems require data entry rather than automatically pulling data from different sources, and do not provide adequate validation and manipulation methods. Existing systems are not very configurable; users cannot easily access different data, change the level of the view, change business rules and criteria.

### SUMMARY OF THE INVENTION

The logistical components of business need a system that gathers correct data in one place and permits users to quickly view data in cross-organizational perspectives and in formats common to all materials. While this invention works, whether the data is provided “real time” or not, from an ongoing logistical use, the ability to analyze a material's current status at any time is particularly useful. Further, the invention's ability to model the logistics off line can be also of significant value. Further, this invention is highly configurable, permitting the user to view different levels of data and change criteria to view different criteria. These criteria can alert users to potential problems and opportunities and assist in addressing any situation. Finally, this invention permits historical trending and analysis. All of these features expedite decisions related to logistics, permitting the user to optimize changing conditions and minimize transaction costs. The features of this invention are used to determine the current status of all data, as well as provide models for the state of data in future periods of time.

The goal of the invention is to collect and organize all available logistical data to create a data repository of inventory and logistical information that will provide an organized view of a company's operations. This data will be used to support queries, reports, alarms, performance calculations and may eventually feed other systems that need this type of information. A preferred embodiment of the invention will make data available throughout the supply chain and all downstream operating groups and interested parties.

The invention provides a method to evaluate the way existing inventory and logistical data is organized and stored as well as the quality and timeliness of the data.

The invention focuses on the following business needs:
Increasing the speed of operations decisions. Current tools provide a time horizon of days and weeks. Data and tools are needed for making operating decisions in hours and minutes.
Increasing operations knowledge across the supply chain.
Operational data needs to be shared across organizational boundaries.
Trending and analyzing operational data to identify market opportunities that might go unnoticed.
Reviewing operating plan compliance and identifying plan deviations. Alarms and alerts will increase the speed of identifying and addressing operating problems.

To meet the objectives, the invention provides three Supply Chain systems:

1. Supply Chain Integrator—This system functions as the inventory and logistical data gathering workhorse for the supply chain. The logistical data is frequently collected from many disparate sources and is converted into a common format for use throughout the company.

2. Supply Chain Visualizer—This system provides easy access to supply chain logistical and associated data using a variety of visualization methods.

3. Supply Chain Business Activity Monitor—This system monitors business and processing metrics and provides notice when thresholds are exceeded or a certain condition exists.

For the purposes of explanation only, the invention will be described herein as it applies to the supply chain of a company operating in the petroleum industry. However, it is not intended that this explanatory description be necessarily limiting upon the scope of the invention as claimed.

The Supply Chain logistics data integrator of the present invention exchanges data with a numerous and varied number of sources and users of logistical information, thus creating an integrated data resource. The invention visually presents logistics data using the Supply Chain technical framework.

The following logistical data is gathered, integrated, visually presented and made available through a corporate computer network or intranet. The following reports are all viewed in an Internet browser window on an authorized users computer:
1. Exchange allocation forms/reports that show terminating partners and their product allocations and current usage of allocations.
2. Sales forecasting forms/reports that show actual sales and forecasted sales by product and by region.
3. Production forecasting forms/reports that show production forecasts and product demand by product and by region.

This invention also provides for the creation of personal warnings and/or alerts triggered when certain operational conditions arise and/or exist. These alerts are delivered via the web portal alerting window as well as several other methods (e-mail, pager, phone call, etc.).

Current Supply Chain logistics data resides in many disparate formats, locations and technologies. The breadth of inventory and bulk transfer data touch points will include data from company operated refineries, terminals, pipelines, retail stores, pipeline movement and schedules, barge and associated movements and schedules, rail cars and associated movements and schedules; and non-company operated terminals, pipeline companies, rail cars, light products pipeline movement and schedules, and ocean vessel movement and schedules.

The invention is developed in four individual modules, each incorporating the Supply Chain Integrator, Visualizer and Business Activity Monitor systems:
1. Basic Translation Masters and All Company Inventory—providing all inventory information for viewing.
2. Inventory Related Data (Sales, Netbacks, Production Forecasts)—providing this additional data for viewing along with the inventory data.
3. Bulk Transfer Data—company (Pipeline, Rail, Barges)—providing all internal bulk transfer data for viewing.
4. Bulk Transfer Data—non-company—providing all external bulk transfer data for viewing.

Although originally designed to meet the needs of the petroleum industry, the invention has application to virtually any industry. It is useful to look at how the invention is applied to the petroleum industry as well as examples of how it would apply to other industries to illustrate its universal application.

### BRIEF DESCRIPTION OF THE DRAWINGS

FIG. 1 is an overview of the invention.

FIG. 2 provides detail of the data acquisition component.

FIG. 3 provides detail of the data validation filters.

FIG. 4 provides detail of the universal data component.

FIG. 5 provides detail of the additional data component.

FIG. 6 provides detail of the visualization component.

FIG. 7 provides detail of the monitoring component.

FIG. 8 is an example of an exchange allocation data screen in a columnar heat grid format.

FIG. 9 is an example of an exchange allocation data screen showing locked out allocation.

FIG. 10 is an example of an exchange allocation screen timeline chart.

FIG. 11 is an example of a sales forecasting screen in a columnar heat grid format.

FIG. 12 is an example of a sales forecasting screen utilizing a bar graph format.

FIG. 13 is an example of a screen using a pie chart format with commodity component breakdown data.

FIG. 14 is an example of a production forecasting screen utilizing a columnar heat grid format.

FIG. 15 is an example of a production forecasting screen utilizing a bar graph format.

### DETAILED DESCRIPTION OF THE DRAWINGS

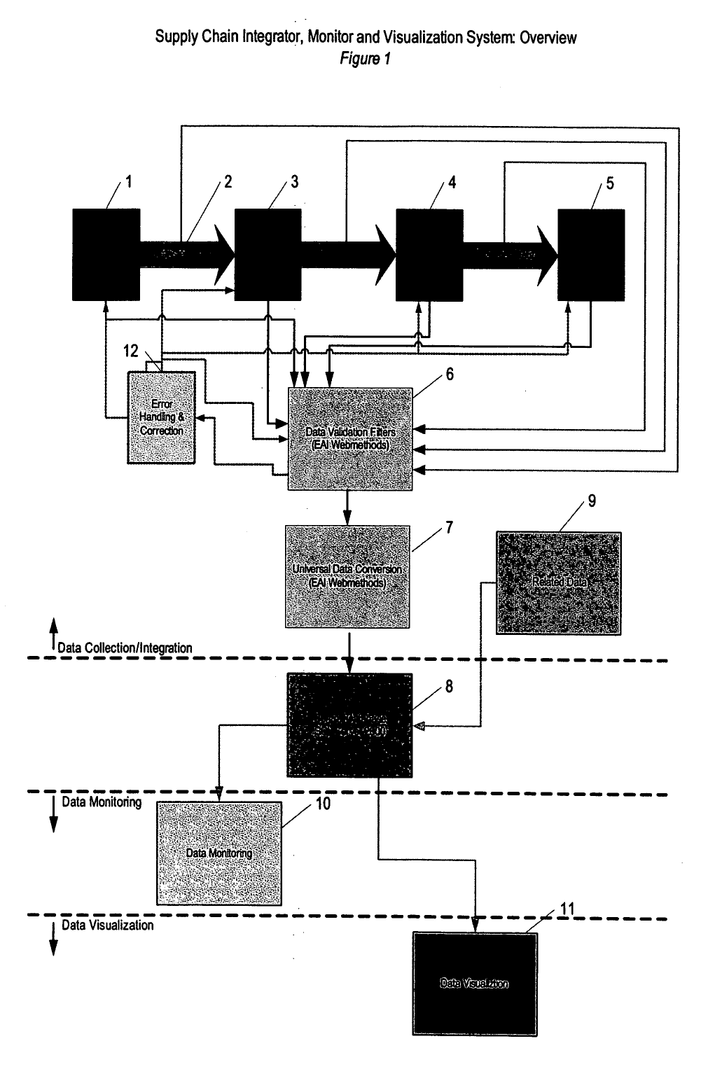

Because the invention consists of a large number of components each containing many variables, a simple overview of the system is helpful in understanding how the system works, FIG. 1 provides a visual overview of the system, representing a typical supply chain. Dependent upon the industry and commodity, the supply chain will vary in scope. Items such as inventory points and transfer data can vary considerably and are industry specific. One of the unique aspects of this invention is that it is configurable and adaptable to meet the needs of various industries.

The entire system may be broken down into three major components, Data Collection and Integration (FIG. 1, items 1-7), Data Monitoring (FIG. 1, item 10), and Data Visualization (FIG. 1, item 11).

Data Collection and Integration

Data Collection and Integration is the information gathering component of the system. As with any database, there is input (information going in) and output (information going out). The flow of the data in FIG. 1 is illustrated by directional arrows connecting various components.

The invention preferably utilizes a software product, WebMethods® to assist in Data Collection and Integration. A database adapter allows WebMethods® to communicate with the central Microsoft SQL Server 2000 database that holds all data. Data may be transferred utilizing a variety of protocols including XML, FTP, or HTTP depending upon the data source. A significant feature of this invention, which sets it apart from other operation data management and control systems, is the ability to gather and integrate information electronically and not rely on physical data entry.

From a process-flow perspective, the Data Collection input comes from all of the processes that occur, from raw material acquisition to delivery of finished product to end users. The data points that are collected are in two major groups, one being inventory data and one being transfer data.

Inventory data may be broken down into:
Raw Material Inventory (FIG. 1, item 1) In the case of the petroleum industry this is crude oil. In the case of a different industry such as citrus fruit growers this is the fruit.
Process Inventory (FIG. 1, item 3). Process inventory in the petroleum industry are stocks on hand or in process at refineries. In the citrus example, process inventory is the stock on hand or in process at processing plants.
Finished Inventories (FIG. 1, items 4 and 5). In the petroleum industry scenario this is stocks of finished goods at storage facilities such as tank farms (FIG. 1, item 4) and stocks on hand at secondary or retail outlets (FIG. 1, item 5). In the citrus example this is stock on hand at warehouses or in the retail distribution channel. The data points in Finished Inventory can vary and are largely dependent upon the industry. In the petroleum industry, one company may control the entire supply chain from crude to processing to retail. In other industry such as citrus growing that may not be the case, therefore the invention is flexible and configurable to meet the needs of a number of different scenarios.

Along with Inventory Data as described above, Transfer Data (FIG. 1, item 2) is the other essential data point acquired in the collection and integration component. The invention has the capability to break down Bulk Transfer Data into two sub parts:
In house Bulk Transfer Data. In the case of the petroleum industry this is data relating to the transfer of inventory controlled by the same company that is refining and retailing the petroleum products. These transfers may include product movement by barge, ship, pipeline, rail, etc. In the citrus growers example, this data relates to any company-owned transportation fleets that are hauling fruit or finished goods. The data being collected may be inventory in-route as well as inventory locations, transfer capacities and costs.
Outside Bulk Transfer Data—this is the same data as in the in-house scenario above, only the data comes from third party companies such as independent pipeline or shipping companies.

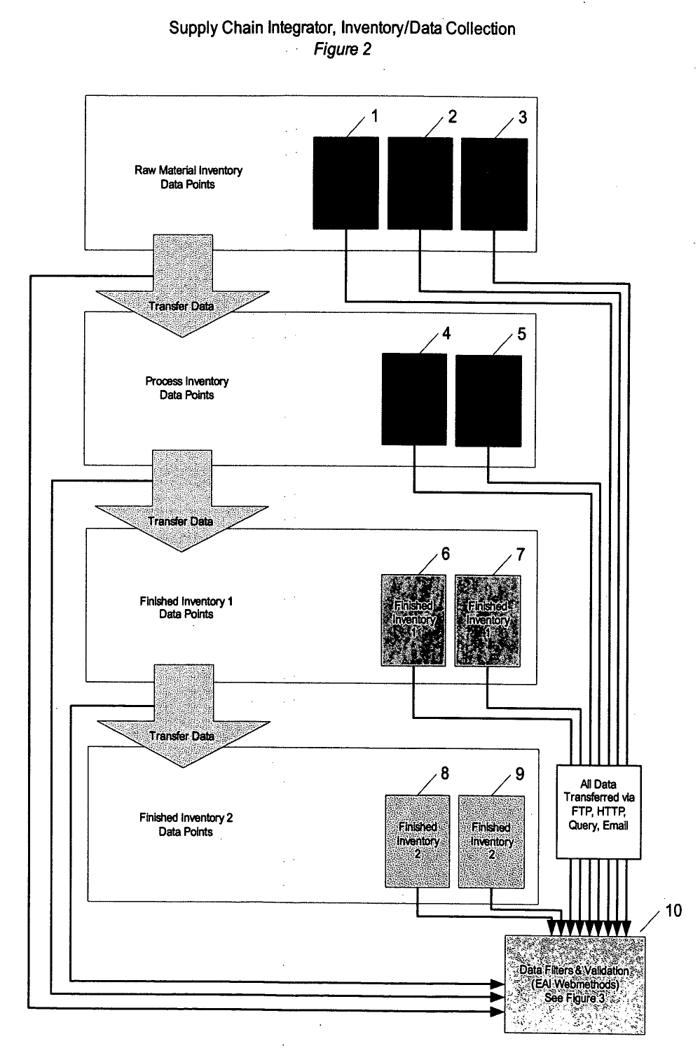

Data acquisition specifics are described in greater detail in FIG. 2.

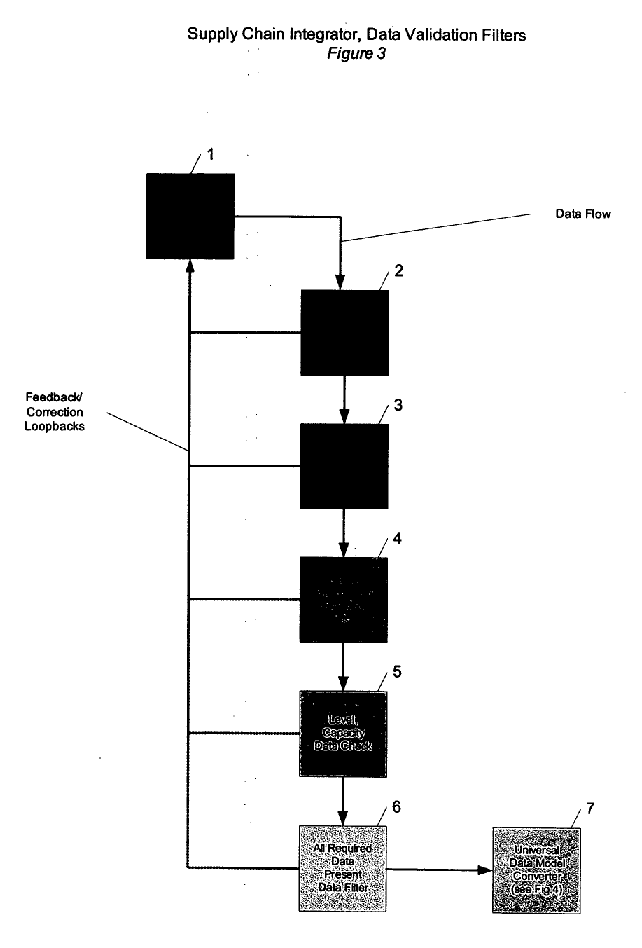

In FIG. 1, item 6 a Data Validation Filter is represented. The purpose of the Data Validation component of the invention is to screen for and remove bad or inaccurate data. A preferred embodiment of the filter utilizes Webmethods® software to apply a set of rules that provide checks and balances to make sure data from the acquisition phase is reasonable and accurate. By utilizing such a validation filter, the invention can catch, eliminate and/or correct any data that was reported erroneously. For example, a holding tank at storage site “A” reports 35,000 gallons of material on hand, but a lookup table in the database filter component shows that the tank has a capacity to hold only 25,000 gallons. This disparity triggers an alert that the data acquired is likely to be inaccurate and requires additional evaluation. In this case, an error handling module (FIG. 1, item 12) will attempt to correct the data and report it to the system. Not only does the validation filtering apply to capacities, but it also monitors date and time records to make sure reporting is concurrent and makes chronological sense. The Data Validation component is described in greater detail in FIG. 3.

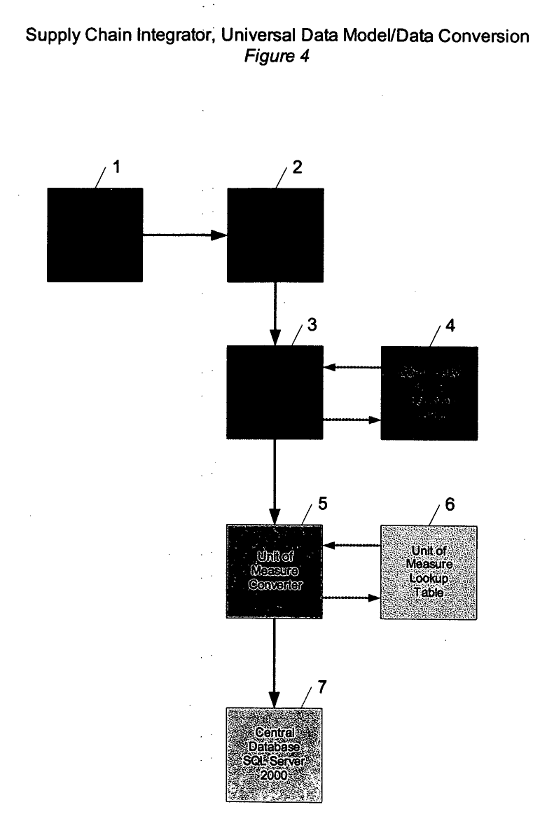

Because the data points collected in the acquisition phase may be extracted from a wide variety of sources, an important component of the invention is its ability to decipher and convert all data to a Universal Data Model. The Universal Data conversion preferably utilizes Webmethods® software and is shown in FIG. 1, item 7. There are a number of factors that need to be universally interpreted when working with data acquired from different sources such as unit conversions (e.g. units of measure) and identifier conversions (e.g. Orange Juice is referred to a s ID 0234 at the processing plant but is ID OJ87 by the transportation company). The task of the Universal Data conversion component of the invention is to make sure all of the data collected is equalized into a common language so unit and identifier fields are consistent regardless of their data source. Integrating data into a universal model is the only way to ensure that the database will yield accurate reporting results. The Universal Data Model is described in greater detail in FIG. 4.

By utilizing a Universal Data Model and a method for Data Validation, the invention maintains an accurate flow of data into its centralized SQL 200 database FIG. 1, item 8).

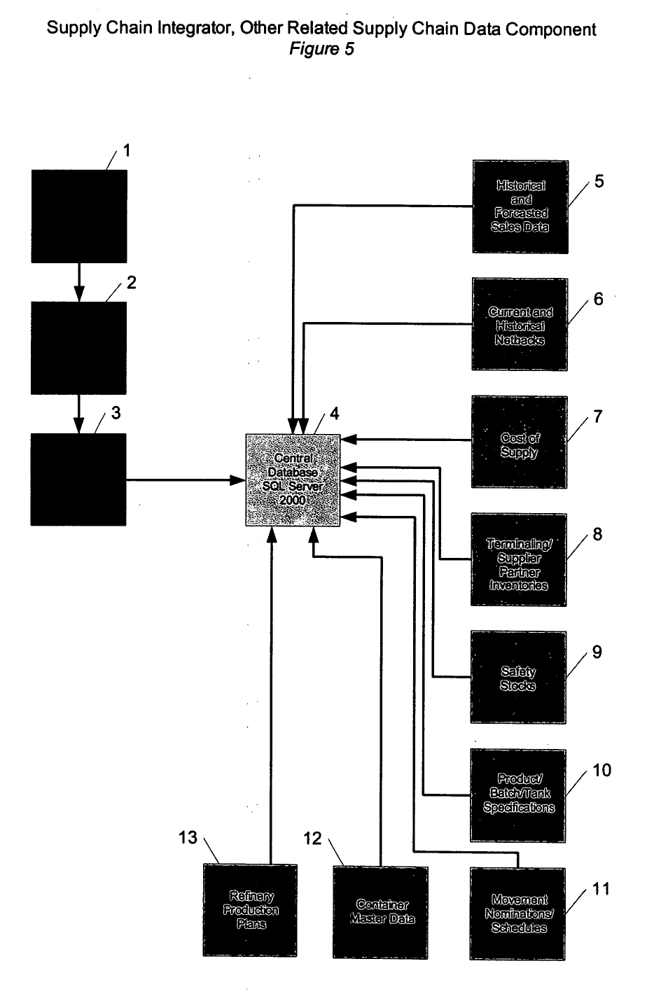

FIG. 1, item 9 represents additional data that the invention utilizes that helps it provide useful reporting in the data monitoring and visualization stages. Because the invention provides logistical supply information that allows personnel to make strategic marketing decisions, additional data is a necessity. Data such as historical sales forecasts, cost of supply, safety stock, production capacities and other items are integrated into the database. By utilizing this additional data along with the dynamic supply-chain data (FIG. 1, items 1-5), the invention can provide meaningful reporting that assists in making informed business decisions. A more detailed description of the additional information used by the system is described in greater detail in FIG. 5.

Supply Chain Monitor

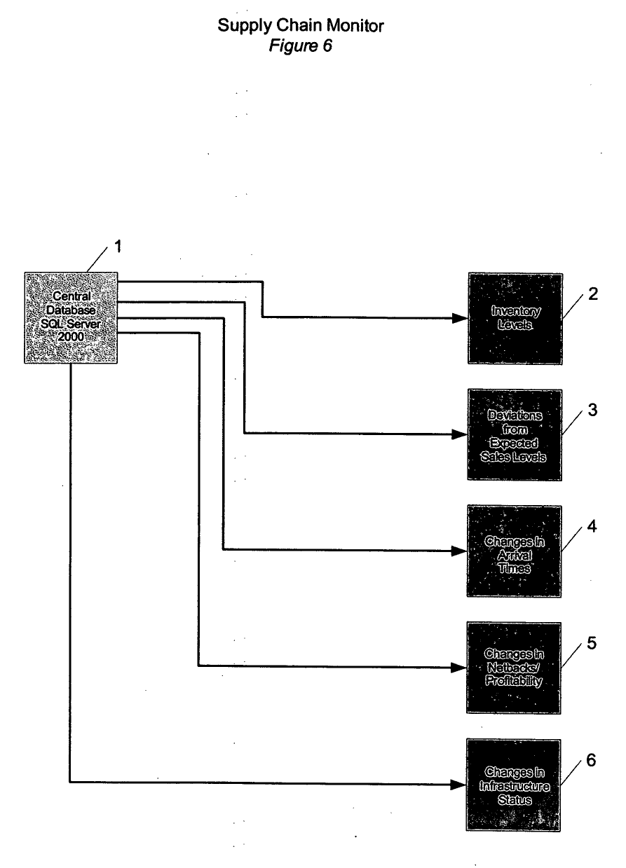

The monitoring capability of the invention is represented in FIG. 1, item 10. The purpose of this component is to give personnel the ability to monitor and/or to be alerted when certain conditions in the supply chain occur. These conditions may include but are not limited to changes in inventory levels, changes in arrival times or other system anomalies that warrant attention. The monitoring component is described in greater detail in FIG. 6.

Supply Chain Visualizer

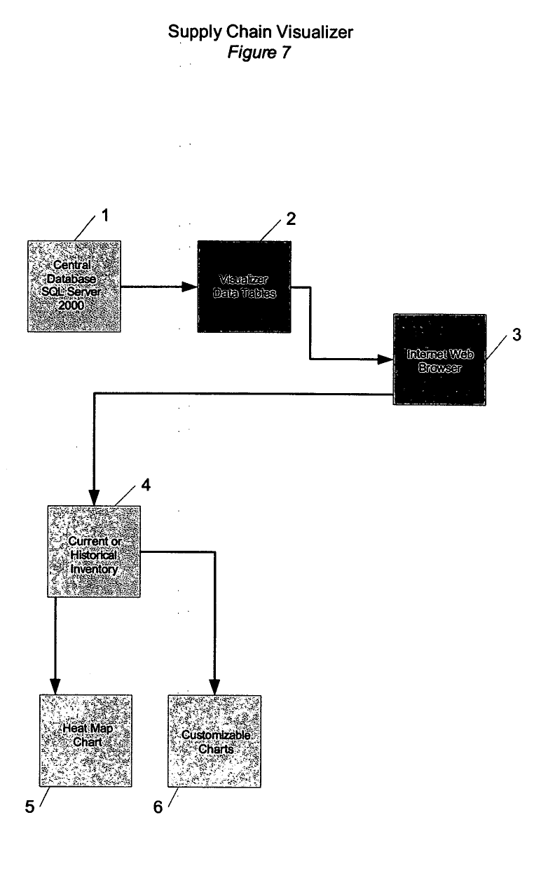

This component of the invention is represented in FIG. 1, item 11. The purpose of the visualizer component is to provide easy access to supply chain logistical and associated data using a variety of visualization methods. The visualizer is explained in greater detail in FIG. 7.

Supply Chain Data Collection in Detail

In order to monitor a supply chain effectively, accurate and timely measurements of all material inventory is essential. The invention is adaptable to a wide variety of industries and therefore has the capability to gather inventory data from a wide variety of data points. In addition to a variety of data points or sources of invention data, the invention has the capability to gather inventory data in a variety of different communication or data transfer protocols. This adaptability, both in the number of data points and various types of data transfer, is essential to making the invention effective in a diverse range of industries.

FIG. 1, items 1-5, show an overview of the major data collection points of the invention. FIG. 2 breaks the data collection points down in greater detail and expands upon the data transfer methods that the system uses to communicate inventory data into its main database. There are three major categories of inventory data in any supply chain, (1) Raw Material Inventory, (2) Process Inventory, and (3) Finished Goods or Finished Inventory. Inventory in transit between any of these inventory categories must also be accounted for.

FIG. 2, items 1-3, show typical data points or inventory points that fit into the Raw Material Inventory category. Raw materials in this case may be any material required to produce a final end product. Examples are crude oil in the case of the petroleum industry, oranges in the case of a citrus products producer or iron ore in the case of the steel industry. FIG. 2, item 1, represents raw material in-field, this could literally be oranges in the field or expected crude oil stocks. Another component of raw material inventory is material that is in transit, for instance on vessels, barges, ships, rail cars, etc. (FIG. 2, item 2). Another data point in this category is raw material in storage. (FIG. 2, item 3).

The second major inventory category from which data is collected is Process Inventory. Process inventory refers to materials being processed into finished goods (FIG. 2, items 4-7). For example, a steel manufacturer has iron ore and coke at a mill where it is being processed into steel, the eventual end product. In some instances there may be several locations or process steps to be accounted for. In the petroleum industry there may be crude oil at a refinery fractionally distilled into gasoline, then the gasoline being moved to a processing plant for completion into fuel.

The final major inventory category from which the invention collects data is finished inventory storage (FIG. 2, items 6 & 7). This refers to finished inventory in warehouses, holding tanks, etc. (FIG. 2, item 6) or inventory stored at retail establishments ready to sell.

Finally, the invention has the capability to collect data about transfer inventory between the raw material and processing phase or between the processing and finished phase. This may be petroleum in pipelines, iron or steel on railcars, or any other inventory being transported.

Because the data points collected come from a wide variety of inventory sources, from refineries to processing plants, intra and iter-company, it is likely that inventory monitoring systems at each source vary widely in the way they record and communicate data. For this reason, the invention has the capacity to receive data using a variety of communication/data transmission protocols. The invention preferably uses the WebMethods® software product which has the capability of receiving data via a number of different protocols including FTP (File Transfer Protocol), a database query, HTTP Get or Post (Hyper Text Transfer Protocol), or via email (POP). Because the software can receive data information in a number of different ways, the invention is highly adaptable to work in a variety of scenarios and industries.

The next step in the flow of information is sending the data to the Universal Data Filter Component (FIG. 2, item 10) which is outlined in greater detail in FIG. 3.

Universal Data Validation and Filtering

Because data is coming from a variety of systems, data item and level “look-up” filters are in place to ensure correct and consistent data. The invention applies a set of rules that provide checks and balances to make sure data from the acquisition phase is reasonable and accurate. By utilizing a validation process the invention can catch, eliminate and correct any data that was reported erroneously. This validation and filtering component is described in greater detail in FIG. 3.

After the data is acquired from the various inventory data points described in FIG. 2, it passes through a number of validity filters. First, the inventory data is checked for physical characteristics (FIG. 3, item 2). For example, if inventory volume of iron ore on a barge is reported as −3000 tons, but a data lookup table reports that the volume number must be a positive number to be valid, then the data is obviously in error and is therefore not valid. At this point, mechanisms are in place to requery the data source to check for valid data.

The next filter (FIG. 3, item 3) is a code/location/company check. If the data acquired shows the commodity number as “xxy”, but there is not a matching commodity number in the data look up table, the data is ruled as invalid. A location and company filter ensures that reported locations and companies are present on the validity lookup table.

Next is a date/time filter (FIG. 3, item 4). This filter makes sure that the date and time reported with the acquired data is valid—e.g., cannot be a future date, date must be reasonable versus last reported date.

The next data filter (FIG. 3, item 5) is a level or capacity validator. This filter checks the data reported for levels. For example, if iron ore in a storage area is reported as 100,000 tons but the storage areas capacity is 50,000 tons, the data is not valid and is required. This filter also checks the data against previous measures. For example, if the previously reported level was 50,000 tons and the current reported level is 20 tons (the difference between the two levels being too great to be reasonable for the time interval between checks), the data may be invalid or erroneous.

The final filter in the validation phase (FIG. 3, item 6) simply checks each data input record to make sure that all of the data required is present. For example, if the data coming into the system is missing a location code, or a commodity code, then the data is incomplete.

If any of the above filter mechanisms find inconsistent, invalid or missing data, the problems are noted and sent back to the data sending system for review and correction.

Universal Data Model/Data Conversion

In order to accomplish a successful and accurate exchange of information from a diverse set of inventory and inventory transfer monitoring systems, converting all data into a universal data format is essential. The invention preferably utilizes the webMethods® software application to convert all data into a consistent, universal formal. In most instances this relates to converting all materials into universal commodity codes or material identifiers and converting all units of measure into consistent units.

FIG. 4 breaks down this conversion component into greater detail. After the data is acquired from the various data points (FIG. 4, item 1) and successfully passes through the data validation process (FIG. 4, item 2), the data then flows into the Universal Data Model (UDM) component.

The UDM component contains lookup tables that are used to identify and convert data. In FIG. 4, item 3, the data flows into a commodity code converter, the converter accesses a lookup table (FIG. 4, item 4) to find universal commodity code values. For example, if processing Plant A identifies milk as commodity code 001 and processing Plant B identifies milk as commodity code MI02, those differing codes must both be converted into a universal code.

Commodity Lookup Table

| | Plant A Code | Plant B Code | Universal Code |
|---|---|---|---|
| Milk | 001 | MI02 | 102 |
| Cheese | 009 | CH01 | 103 |
| Cream | 023 | CR05 | 104 |

After the commodity codes are converted to a universal format, the data is next converted into standardized units of measure (FIG. 4, item 5). Quite simply, this converts values such as barrels to gallons, liters to gallons, kilograms to pounds, etc. These conversions are again achieved by looking up values and conversion data in a lookup table (FIG. 4, item 6). The purpose of this conversion is to make sure all values are consistent, ensuring accurate, universal data.

After the data commodity codes and units of measure are converted, the data is then sent to the centralized SQL Server 2000 database (FIG. 4, item 7).

Additional Data Integration

In addition to the acquisition of dynamic actual inventory and inventory in transit data, the invention has the capability to integrate additional data into its central database. Because the invention provides logistical supply information that allows personnel to make strategic marketing decisions, this additional data is often a necessity. FIG. 5 shows the additional integrated data in more detail. Although FIG. 5 uses primarily a petroleum process model, as with all other components of the invention, the system is highly adaptable to work with a variety of industries and their specific needs.

Some of the additional data points integrated into the system database include Historical and Forecasted Sales Data (FIG. 5, item 5). This information is useful in identifying fundamental supply and demand issues that may occur in a supply chain. In addition, current and historical netbacks are reported (FIG. 5, item 6). Netbacks refer to profits after paying production, transportation and other costs and varies with supply costs. This information provides a picture of profitability based on raw material costs. Also, cost of supply or raw materials is factored into the system (FIG. 5, item 7). Inventories on hand at suppliers locations may be factored into the database (FIG. 5, item 8) as well as any safety stocks on-hand that may be pulled in for production (FIG. 5, item 9).

Additional ancillary data such as container and product specifications (FIG. 5, item 10), movement and shipping schedules (FIG. 5, item 11), container and stock master data (FIG. 5, item 12) as well as production plans (FIG. 5, item 13) is also integrated into the supply chain central database.

The four individual components outlined in FIG. 2 (Inventory Data Acquisition), FIG. 3 (Data Validation/Filtering), FIG. 4 (Universal Data Model/Conversion), and FIG. 5 (Additional Data) make up the Operational Data Management and Control system of the invention.

Supply Chain Monitor

The Supply Chain Monitor System (FIG. 1, item 10) gives users of the invention the ability to monitor, alert, and send messages based on various supply chain operating conditions. Although primarily accessed on networked computers, the system is customizable for interfacing with handheld computers and other communication devices such as fax machines, voice mail, pagers, etc. Users of the system have the ability to set custom alerts. These alerts are useful in managing supply shortages, modifying product sell prices, etc. The system has the ability to send different levels of alerts dependent upon the potential impact a situation in the supply chain may have. The system also has the capability to capture alert histories in a log or journal. Further, the alerts are intelligent in that the alert will cease once the situation has changed.

Although completely customizable for a number of different scenarios, FIG. 6 illustrates a typical supply chain monitoring scenario. Since the central database (FIG. 6, item 1) holds all inventory and historical data, a variety of different parameters may be monitored. FIG. 6, item 2 shows an example of an inventory level monitoring component which looks at up to the minute inventory levels of items in the supply chain, such as raw materials or finished product.

In FIG. 6, item 3, sales levels are monitored and deviations are noted. By monitoring sales levels the invention has the ability to adjust production or raw material movement as needed. Item 4, FIG. 6, is an example of a change in arrival time monitor. For example, if a barge carrying iron ore runs aground and will be delayed, it may cause interruption at a mill. By monitoring arrival times the system gives operators time to divert supplies from other locations to prevent an operational interruption without an interruption in the supply chain. FIG. 6, item 5 is an example of a monitor that watches netbacks or profitability. Changes in the cost of raw materials such as crude oil or iron ore as well as changes in production costs need to be monitored so market pricing may be adjusted accordingly. Lastly, FIG. 6, item 6, represents a infrastructure status monitor. For example, if a pipeline in a transfer network breaks causing a change in the supply chain infrastructure, managers can be alerted and adjust flow logistics accordingly.

As illustrated by the various monitor scenarios described above, the invention has the ability to monitor the status of all components of a supply chain and provide a useful set of monitoring and alerting tools that assist in making logistical product and pricing decisions.

Supply Chain Visualizer

This component of the invention is represented in FIG. 1, item 11 and in greater detail in FIGS. 7-15. The purpose of the visualizer component is to provide easy access to supply chain logistical and associated data using a variety of visualization methods.

The visualizer component provides users with the ability to access graphic and text based inventory information over a computer web browser (FIG. 7, item 3) and customize the way that the data is presented. It gives users the ability to view detailed or summarized data in a number of different formats. The visualizer gets its data from the current inventory tables of the centralized database (FIG. 7, items 1-2). The specific graphs and visual representations are flexible and customizable and may include a variety of charts such as Heat Charts (a type of visual display with color shading that identifies out of range situations) and other customizable chart views (FIG. 7, item 6).

### SPECIFIC EXAMPLE OF INVENTION IN APPLICATION TO THE PETROLEUM INDUSTRY

Supply Chain Data Integration

The inventory data must be captured once as close to the source as practical. Terminal data, refining data, and pipeline data are captured and updated every hour. Retail data is captured from the Automatic Tank Gauging systems located at the stores.
Inventory and bulk transfer data are translated into a common format. All inventory records in UDM look the same, regardless of the source of the data.
Inventory readings are taken as close to real-time as possible. Also, inventory readings are required for “all” business locations (refineries, terminals, retail stations, pipelines) not just those that have automated gauging systems.
The data is available as volumetric readings (gallons/barrels, etc.). All level measurements will be converted to volumes.
Internal system integrity checks and alarms are part of the system to make sure the data is of the highest quality and timely. A series of data cleansing related integrity checks is designed into the system.
All of the various related attributes of inventory and bulk transfer data are captured and made available. These include, but are not limited to things such as: location, container type, commodity ownership (terminaling/exchange), RVP, pump and arrival data, temperature, time/date stamping, lab reports, etc.
A historical view of the data is created and maintained.
Master container (tanks, barges, railcars, pipelines) data is needed along with all attributes of the containers. (Capacity, bottoms, in-service, alarm, etc.). This data is also date and time stamped so that the latest changes will be known. Master container data is gathered from numerous sources and aggregated into a common format and file to be used when presenting the data.

Because inventory and bulk transfer data comes from a diverse set of systems, extensive data item and record level edits are created to ensure the data is correct and consistent. Problems are noted and reviewed with the sending systems. This is a very important and complex task individual to each set of data. There are a myriad number of ways a record can have bad or incomplete data. A sample of a few of the possible edits follows:

Inventory Data Item Level

1. Volume, temperature, gravity data.
a. Is it reasonable?
b. Is it a positive number?
c. How much has it changed since the last reading?

2. Secondary keys into location, company etc.
a. Does it match the secondary key file or do we have some bogus company, commodity, location etc.

3. Date/Time
a. Cannot be a future date
b. Reasonable vs. previously reported date

4. Level
a. Reasonable vs. previous reported level?
b. Positive number?
c. Does it fit within the size of the tank?

5. Required data items
a. Which data items must be present on each record

6. Is the value correct?
a. Other than checking for reasonableness, comparing to prior values for the same record etc.

Each inventory and bulk transfer record must be translated into a common format of consistent commodity codes, units of measure, locations and other data. A common petroleum company might need the invention to interface with numerous external pipeline companies, barge companies, outside operated terminals, refineries as well as several internal entities, each having their own codes for commodities and so forth. Tables are established by the invention to translate these codes into a common looking consistent record.

In addition to compiling inventory and actual movement data, there is other data that fills out the supply chain picture. The following master and other ancillary data may be variously included in the database.

Historical and Forecasted Sales—Sales are a key component of the supply chain. Historical and forecasted sales data for terminals and retail stores is presented. For terminal sales this data is broken down by class of trade.

Current and Historical Netbacks—Netbacks add the element of profitability to the supply chain picture.

Cost of Supply

Terminaling Partner Inventory—How is the total inventory broken out between each terminating partner.

Safety Stock—The normal required safety stock at a terminal or refinery is useful in determining the bbls available for shipment/sales.

Tank/Batch Specifications and Standard Product Specifications

Movement Nominations and Schedules—In addition to the actual movement, there are numerous nominations that need to be passed on to carriers and carrier schedules that are helpful.

Container Master Data—The invention accesses inventory information about many different containers. Each one of these containers has attributes that are helpful in the Data Presentation and Alerting portions of the system. For example: Safe Fill Volume, Low Level Volume, Bottoms, Safety Stock Volume, In Service/Out of Service designation, Off Spec Product designation, Location, Tank ID etc.

Refinery Production Plans—The presentation of refinery run rates and production plans are helpful in data collection and presentation.

Like the inventory and bulk transfer data, because the master data comes from a diverse set of systems, extensive data item and record level edits are created to ensure the data is correct and consistent.

Supply Chain Monitoring

This includes the ability to monitor, alert and send messages based on various operating conditions. Examples include the following:

1. Inventory Levels

a) Too high/containment (will the next batch fit?)
b) Too low/run out
   2. Sales Levels or Refinery Production Runs (look out two weeks?)
a) Deviations from expected
b) Acceleration/Deceleration
   3. Netbacks (for wholesale class of trade—incremental sales)
a) Absolute levels and changes
b) Relating netbacks to inventory levels
   4. Bulk Transfers
a) Timing changes
b) Volume changes.
   5. Changes in Infrastructure Status
a) Tank status changes
b) Other facilities alerts
   6. Miscellaneous
a) Product temp<X degrees F.
b) (Product temp on tank−Product temp on bulk transfer)>X degrees F.
   7. Data Integrity
   (Current time−Last update time)>X hours
a) (Reported inventory−safe fill)>X barrels or (Bottoms−reported inventory)>X barrels
b) Commodity type for bulk transfer to/from facility not equal to commodity types stored at facility
   Supply Chain Visualization

Certain data is presented graphically in columns and rows sorted by a metric. Color shading identifies out of range situations. This is type of display is called a heatmap.

The invention includes the following types and quantities of heatmaps:
Inventories—Retail—show days/hours of remaining inventories for all Retail stores. Can click on box and go to store's inventories screen.
Inventories—Light Products—show all terminal's ranking by volumes or days of sales based on available inventory for a specified product. For example, would have four/six gasolines and three distillates (kerosene, HS, LS). The maps are filterable to view only a subset of terminals.
Bulk Transfers—show ‘system’ batches delayed vs. advanced ranked by time change magnitude.
Netbacks—show screens of current netbacks by gasoline, kerosene, HS, LS at the terminal level, using a screen for each product. Varying size of boxes indicate total revenue contribution.
Sales Levels—show terminal sales over/under forecast ranked by volume or percentage, using one screen for each basic product.
Quality—RVP level by terminal, one screen per octane level.
Quality—Cloud point by terminal.

In addition to the heatmaps described above, other components of the supply chain visualization include:
Exchange Allocation Forms
Sales Forcasting Forms
Production Forecasting Forms

Exchange allocation forms are used to graphically illustrate product usage between petroleum companies that have product exchange agreements. Often, petroleum companies will have exchange agreements where ‘Company A’ can get products with their custom additives or formulations from ‘Company B's’ refineries and vice versa. Typically, each company in an agreement will have strict guidelines to follow such as how much product they are allocated on a daily basis, a ten day basis and a monthly basis. Companies that reach their allocation may be locked out or prohibited from taking any more inventory from a terminal. These exchange agreements typically are on a per product, per region and per company basis requiring the monitoring of a variety of product, company and regional metrics. The Exchange Allocation Forms allow the user to visually monitor allocations with other companies.

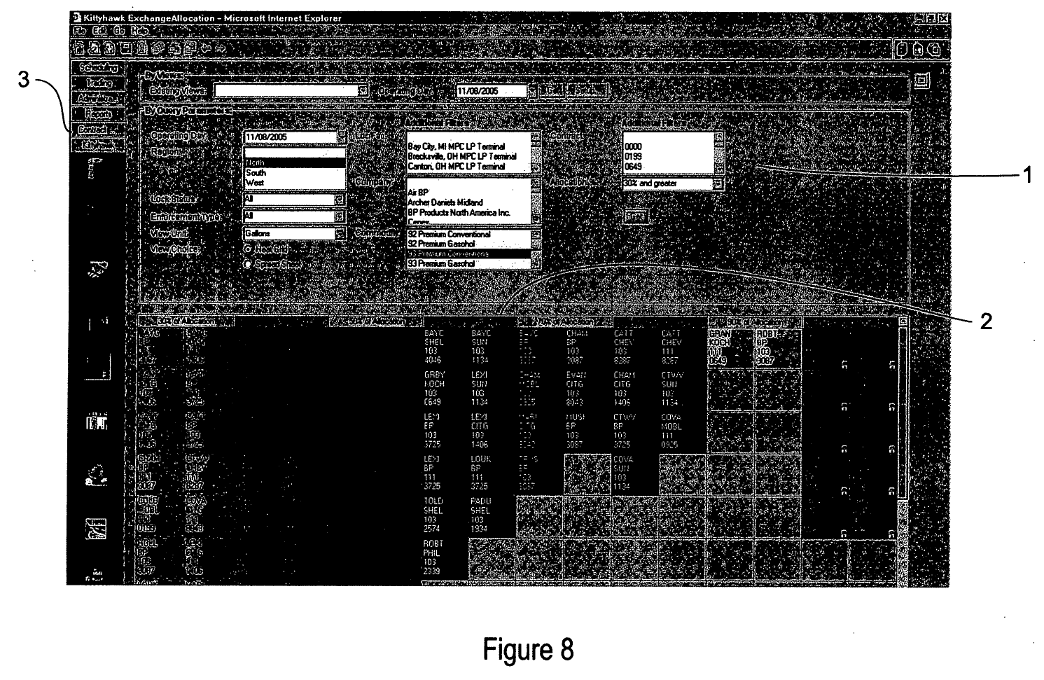

FIG. 8 shows a “heat grid control” type visual display containing exchange allocation data. This type of display is accessed by company personnel via a corporate intranet on users computers. At the top of the display (FIG. 8, Item 1) are data parameters and filters that may be selected by the user to select what allocation data they would like to view. The parameters determine what allocation data is shown and include selections such as Date, Region, Allocation Lock Status, View Unit, Location Facilities, Company, Commodity, Contract Numbers and Allocation percentages. The lower part of the screen is the actual heat grid which is a visual representation in grid form (FIG. 8, Item 2) that utilizes a columnar layout and colors to represent different allocation use percentages. In each cell of the grid, location, company, product, and quantity data is listed. Each column of the grid represents a different percentage of allocation that is used. In the grid on FIG. 8, Item 2, the allocation percentage columns show those companies that have used from 30% to 100%. In the 100% allocation column a graphic “lock” icon appears which signifies that the company is locked out or has used 100% of it's allocation and therefore is prevented from receiving any more product. FIG. 8, Item 3 is a navigation bar which allows users to navigate to different areas of the system.

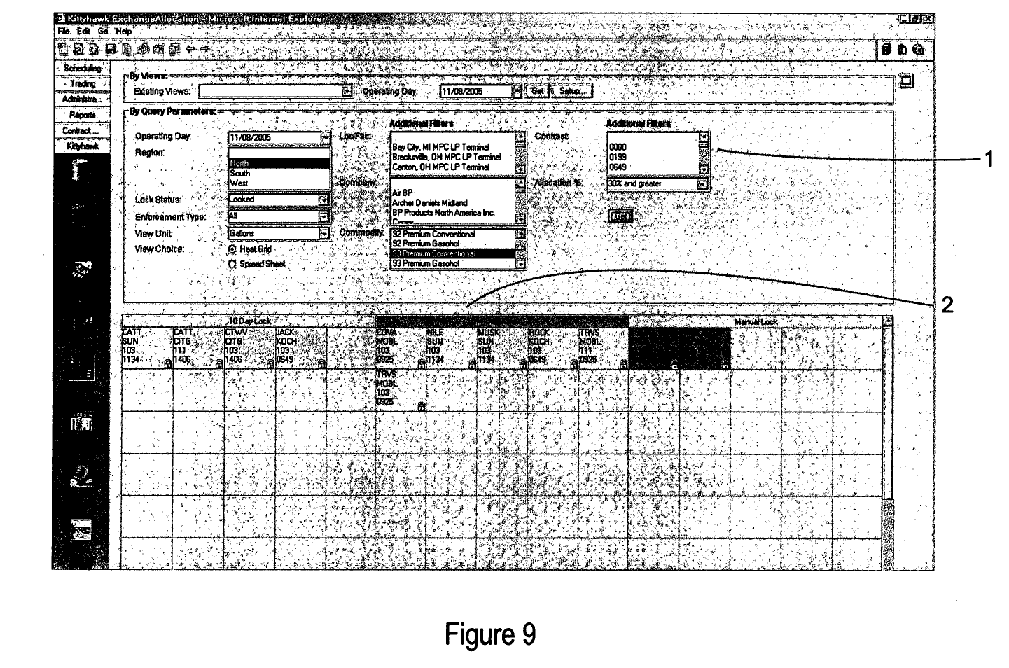

FIG. 9 shows a heat grid control display similar to the screen in FIG. 8 only in FIG. 9 the grid (Item 2) is showing only those companies who are locked out from receiving more product due to full use of their allocation. There are five types of lock outs in the system including daily, 10 day, monthly, manual and zero allocation. The heat grid control is a columnar display which identifies the data grouped by the type of lock only. There are only 5 colors and they are only used to distinguish between the columns.

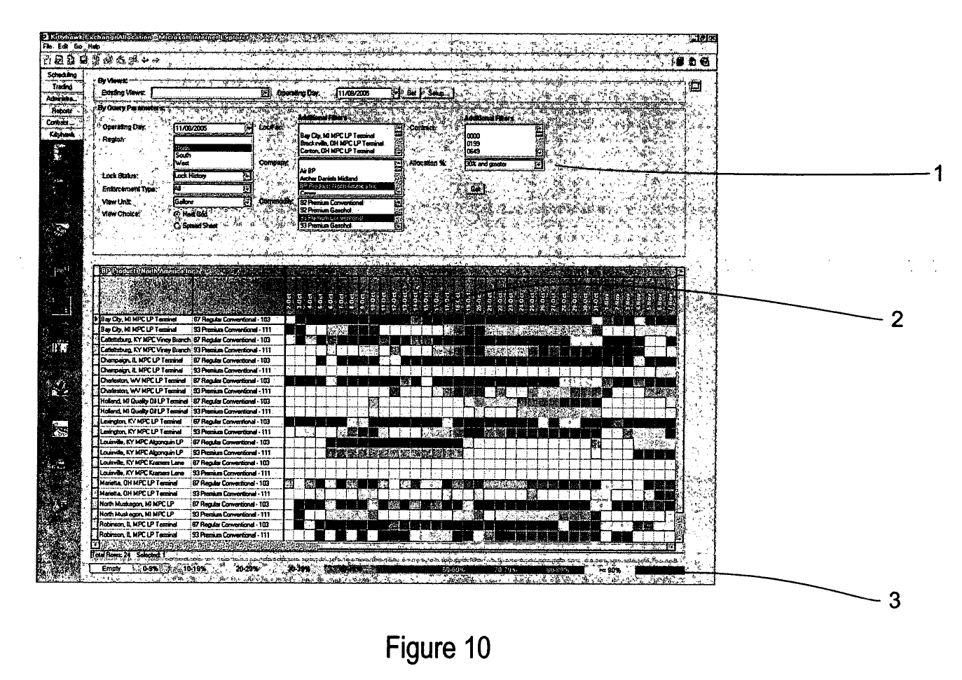

FIG. 10 shows a grid timeline control display that is useful in identifying trends. As with FIG. 8, FIG. 10, Item 1 includes data parameter choices. The grid in FIG. 10, Item 2 can show up to 60 days of data. This time grid shows companies by product and if and why they are locked out. For example, on the timeline a trend may be seen where a certain company is always getting locked out early in the month, this in turn could prompt a determination as to whether the company needs a higher allocation or an investigation as to why they are pulling such a high volume so quickly. On the other hand, a trend may be spotted where a company never comes close to reaching its allocated limit, indicating that product is on site and not used. This trend may prompt a lowering of future allocations, assigning the allocation to another customer, or allocating the product internally. The data grid utilizes a color-coding system to assist the user in quickly spotting extreme values. The color scale at the bottom of the screen (FIG. 10, Item 3) shows what colors represent what percentages of product allocation used such as red representing 100% of their allocation and white representing 0% allocation.

As part of the system, commodity/product sales data is captured and sales forecasts are made on how much of a commodity will be sold on a per terminal, per product and per company basis. The data is captured for prior months, current months and forecasted up to a year into the future. The actual sales data is also captured which allows for an actual-to-forecast comparison.

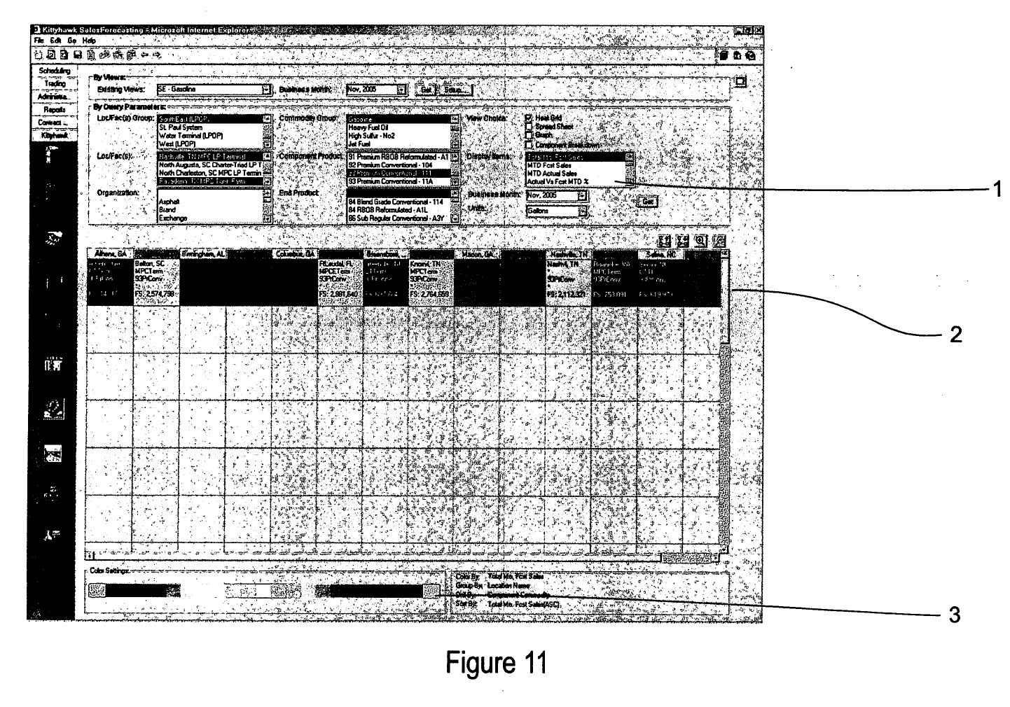

FIG. 11 shows one type of visual display form used in sales forecasting. The data view in FIG. 11 gives the user a group of data parameters to choose from (FIG. 11, Item 1), the parameters include choices such as Location Groups, Locations, Commodity Groups, Products, Units, Time frames and View Choices. FIG. 11 chooses the “Heat Grid” view choice which refers to the format in which the forecast data is displayed. Each Location Group consists of multiple locations and the user may pick multiple locations in the same location group for viewing sales forecasts on a per location basis. The data heat grid display (FIG. 11, Item 2) is a table in which each column represents a location. Different colors are used in each cell of the grid and the colors signify the forecast volume data. In the FIG. 11 example, the color coding spectrum of the cells is in a color range from deep red to blue with white in the center of the spectrum (FIG. 11, Item 3). In this example, the deep red signifies a minimum or low value (a low sales forecast), and the blue cells signify a forecast on the high forecast range. This gives the user the ability to spot problem areas at a glance. For example, the user may want to find out why the locations with the dark red squares have a very low sales forecast. The locations that have blue squares indicate a high sales forecast which may prompt an investigation into why the forecast volume is so high. By utilizing color schemes in a grid, the user can quickly determine what areas need to be looked at first.

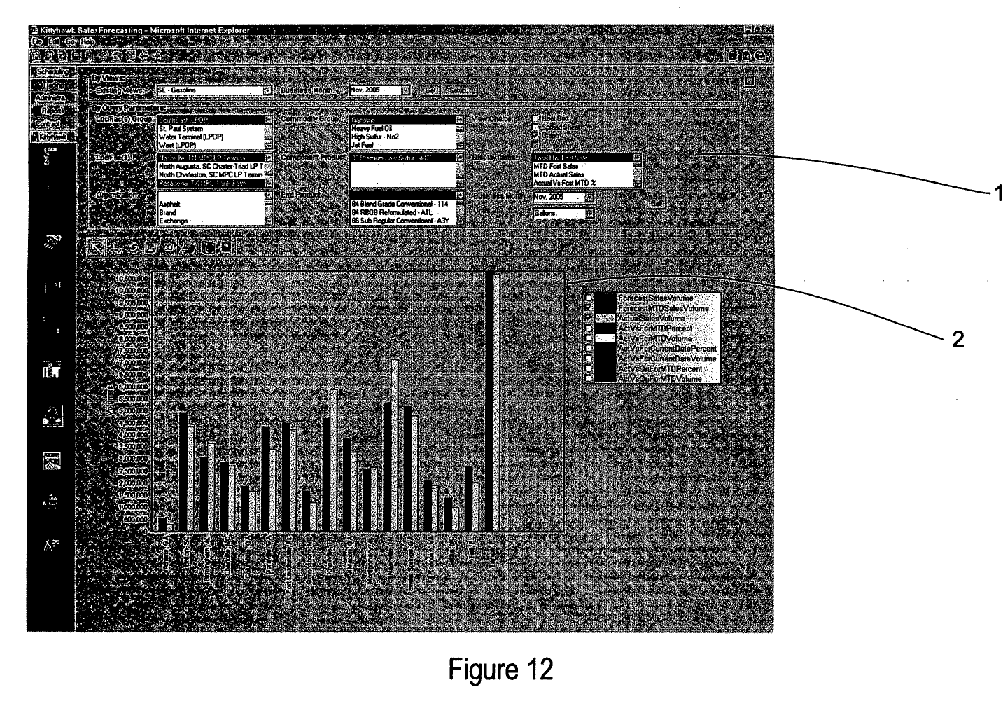

FIG. 12 shows the sales forecasting form only with the “Graph” option selected in the view type parameter section (FIG. 12, Item 1). In this case, the display items selected show in a graph form (FIG. 12, Item 2) the forecasted sales versus actual sales by location. This allows the user to spot any locations that have actual sales that are higher or lower than forecast.

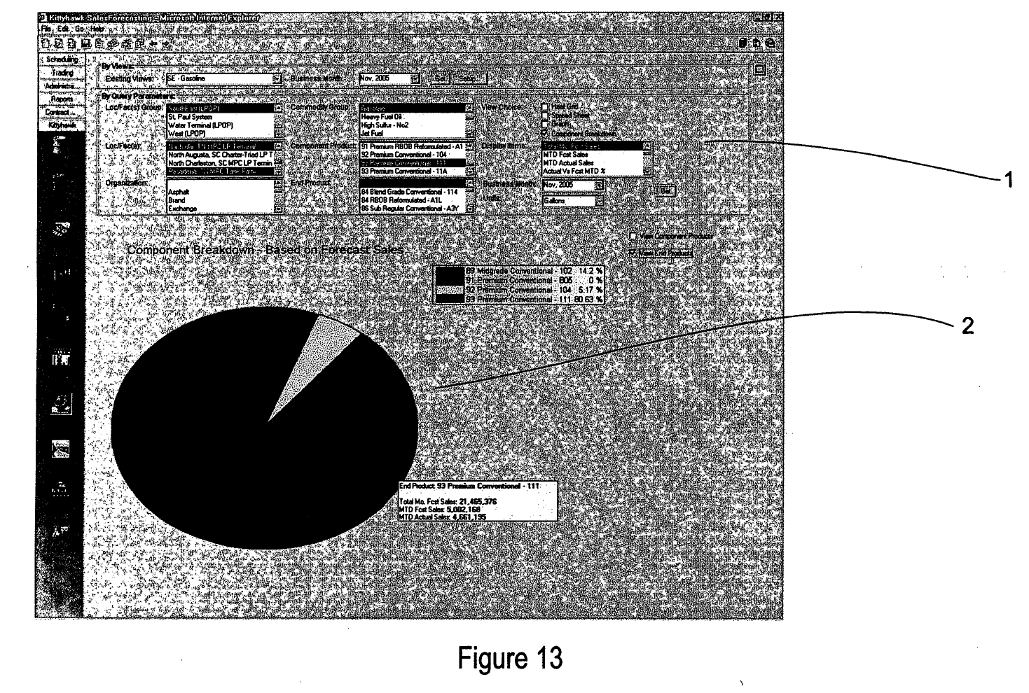

FIG. 13 shows a sales forecast chart by component breakdown. In many cases end products, such as different grades of gasoline are made using a component product. So, in the example on FIG. 13, in the forecasted product sales total for product 93 octane conventional gasoline, a certain percentage of the total will be used to produce 89, 91, and 92 octane conventional gasoline. In the query parameters selection area (FIG. 13, Item 1), there are list boxes listing Component Products. Once selected, the applicable end use products made from that component product may be selected. Based upon these parameter selections, the pie chart graph (FIG. 13, Item 2) shows the sales forecast of the component product, and what percentages of the component product are forecasted to be used to make the end use products selected.

The production forecasting capability of the system forecasts how much of a commodity will be produced at refineries. This production data is captured for prior months, current month and several months into the future. There are volumes captured for demand, forecasted and actual, which allows for different comparison calculations.

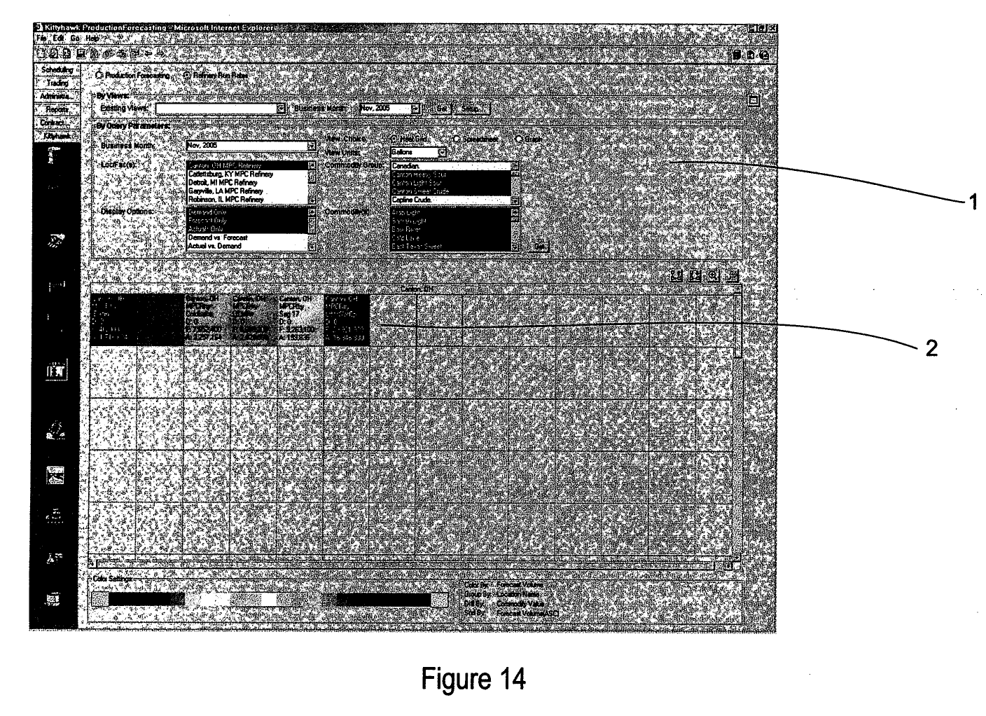

FIG. 14 displays the data in a heat grid control which is a color-coded columnar layout. As with the other data display forms in the system, the top section (FIG. 14, Item 1) presents the user with several data viewing parameter choices, including whether the data is for production forecasting or refinery run rates, view type, business month (date), locations, display options, view units, commodity group and specific commodity. Once the user makes the data query parameter choices, the data is shown in the heat map grid (FIG. 14, Item 2). As with the other heat map type displays in the system, color coding is utilized so that the user can quickly spot “extreme” data situations that may demand action. This is achieved by identifying unusually high or low data values by colors on each end of a spectrum such as red to blue with red values identifying one extreme range and blue values representing the opposite extreme range. There are “group by” and “drill down features” that allow the user to examine specific data more closely.

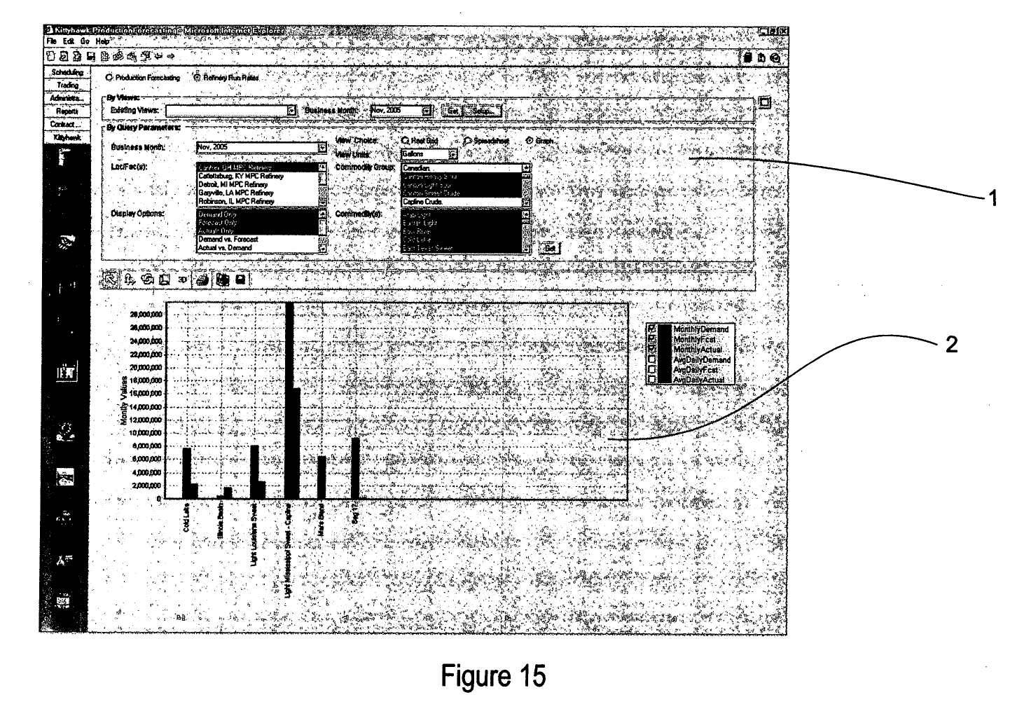

FIG. 15 shows forecasting data in a graph format. This graph format allows the user to graph data based on a selection of commodity groups and allows viewing of any combination of data items such as month to date or current day information. As with other graphs in the system, there are data query parameter selections at the top of the form (FIG. 15, Item 1) and an area for the graph display at the bottom of the page (FIG. 15, item 2).

The above description of the invention and the given example for the petroleum industry is intended to be illustrative and is not intended to be necessarily limited upon the scope and content of the claims, which follow.

We claim:

1. A system for visualizing supply chain data in the petroleum industry comprising the use of a heat grid control visual display and including a plurality of user controlled data parameters and filters; wherein the data is received in grid form utilizing a columnar layout and color representations of differing levels of data.

2. The system of claim 1 wherein the parameters relate to exchange allocation data and may variously include data related to date, region, allocation lock status, view unit, location facilities, company, commodity, contract numbers and allocation percentages.

3. The system of claim 2 wherein the grid is comprised of cells, each cell containing data on the location, company, product and quantity of product.

4. The system of claim 3 wherein each column of the grid represents a different percentage of allocation that is used.

5. The system of claim 2 wherein the grid identifies those companies that have used 100% of their periodic allocation and are locked out from receiving further product.

6. The system of claim 2 wherein the grid displays a plurality of days of data creating a timeline showing each company and the allocation of product for each company and the percentage of the allocation actually taken by the company.

7. The system of claim 1 wherein the parameters relate to sales of product and the forecasting of sales of product as to how much product will be sold on a per terminal, per product, per company basis.

8. The system of claim 7 wherein the parameters displayed variously include data on location groups, location, commodity groups, products, units, time frames and view choices.

9. The system of claim 8 wherein each column of the grid represents a location and each cell of the grid is viewed in a variety of colors, each color representing a different forecast volume.

10. The system of claim 7 wherein the data is presented in a graph format showing forecasted sales against actual sales by location.

11. The system of claim 7 wherein the sales forecast is presented utilizing data representing individual component products to forecast percentages of end-use product derived from the component product.

12. The system of claim 1 wherein the parameters relate production of product and the forecasting of production for specific products.

13. The system of claim 12 wherein the parameters displayed variously include data pertaining to refinery run rates, view type, date, locations, display options, view units, commodity group, and specific commodity.

14. The system of claim 1 wherein the data is automatically collected from the multiple sources.

15. The system of claim 1 wherein the data gathering is performed in real time.

16. The system of claim 1 further including the step of configuring the data to permit the data to be viewed in multiple levels of detail.

17. The system of claim 16 wherein the step of configuring the data permits the ability to provide for historical trending and analysis.

18. The system of claim 16 wherein the step of configuring the data permits the ability to provide modeling for the future.

19. The system of claim 1 wherein the data being gathered comprises inventory data and transfer data.
